(19) United States
(12) Patent Application Publication
(10) Pub. No.: US 2015/0174685 A1
(43) Pub. Date: Jun. 25, 2015

(54) Integrated Multi-Task Metal Working System

(71) Applicants: Michael Tracy Ward, Monticello, AR (US); Mark Dane Hartness, Monticello, AR (US)

(72) Inventors: Michael Tracy Ward, Monticello, AR (US); Mark Dane Hartness, Monticello, AR (US)

(73) Assignee: BARRACUDA SYSTEMS, LLC, Monticello, AR (US)

(21) Appl. No.: 14/355,300

(22) PCT Filed: Oct. 11, 2012
(86) PCT No.: PCT/US12/59749

§ 371 Date: Apr. 30, 2014

Related U.S. Application Data
(60) Provisional application No. 61/628,443, filed on Oct. 31, 2011.

(51) Int. Cl. B23K 10/00; B23K 9/10

(52) U.S. Cl. CPC B23K 10/00; B23K 9/1006

(57) ABSTRACT

A self-contained integrated unit (10), including an engine (11) driving an electric generator (12), air compressor (21) and plasma cutter (30). The engine (11) drives the air compressor (21) for producing compressed air for the plasma cutter (30). A pair of compressed air tanks (20) provides for storage of the compressed air. The compressed air tanks (20) are situated at bottom opposite sides of the structure that houses the components of the unit (10) so that the tanks (20) also act as skids for ease of movement of the unit (10) to the next cutting site. The structure that houses the engine (11), electrical generator (12), air compressor (21), plasma cutter (30) and related auxiliary equipment includes suitable covers and access ports. The structure also includes attachment points (31) and devices for ease of lifting and moving the entire unit (10) as needed for cutting work and transport. Compressed air and electric power is supplied to the torch of the plasma cutter (30).

This application claims the benefit of U.S. Provisional Patent Application No. 61/628,443 filed Oct. 31, 2011, which is incorporated herein by reference in its entirety.

### TECHNICAL FIELD

The present invention relates to an integrated multi-task metal working system, and in particular, to such a system suitable for field cutting of oil and natural gas pipe and related tasks.

### BACKGROUND ART

In the oil and natural gas pipeline business, it is necessary to cut and precision finish the pipe in the field. Pipe cutting has traditionally been done with oxyacetylene cutters. However, oxyacetylene is expensive and the resulting cut is typically ragged and fouled with slag. The cut must then be reworked and cleaned up with a grinder until it is suitable for being welded to an adjacent section of pipe.

A much more desirable cut can be made with a plasma cutter. Plasma cutters operate by blowing pressurized inert gas, such as air, through the nozzle of a torch. An electrical arc is established in the pressurized gas from the nozzle to the metal. The electrical arc melts the metal which is then blown away by the pressurized gas. A plasma cutter is capable of a much cleaner and more precise cut, requiring minimal, if any, reworking. Plasma cutters also cut at speeds several times the speed achievable by oxyacetylene cutters with typical oil/gas piping material, are significantly more energy efficient, and do not involve the use of explosive liquids/gases. However, the drawback with using a plasma cutter in the remote areas generally involved in pipeline construction is that electric utility lines are unavailable or inaccessible to supply the significant electrical power required by a plasma cutter.

The limitations of the prior art are overcome by the present invention as described below.

### DISCLOSURE OF INVENTION

The present invention solves these problems and limitations in the prior art by providing a self-contained integrated unit, including an engine (preferably a diesel engine) driving an electric generator, air compressor (preferably a screw-type compressor) and a plasma cutter. The unit is portable and light enough to ride comfortably in the back of a typical ¾ ton (680 kg) pickup truck or on a small utility trailer so it can go directly up to the pipe that needs to be cut. In one embodiment, the unit contains a sled feature that permits a worker to simply slide the unit over to the next cutting site.

The diesel electric generator includes a turbo-charged diesel engine driving an electric generator. Appropriate auxiliary equipment for operating the diesel engine and electric generator, including integral fuel tank, oil cooler, 12 volt battery, and controls, are provided as well. The diesel engine drives a screw compressor for producing compressed air for the plasma cutter. The compressor is configured with oil and water coolers, oil separator, water separator and reserve air tank(s) in order to supply the constant, clean, dry and stable air flow necessary for proper operation of the plasma cutter. The compressed air is cooled in the water cooler, dehumidified in the water separator and cleansed in the air filter. One or more compressed air tanks provides for storage of the compressed air. If more than one compressed air tank(s) are employed, they are desirably interconnected. In one embodiment, a pair of compressed air tanks are situated at bottom opposite sides of the structure that houses the components of the unit so that the tanks also act as skids for ease of movement of the unit to the next cutting site. The walls of these tanks are thicker than would be required for compressed air service alone in order to safely act as skids. The structure that houses the components of the unit, including the diesel generator, air compressor, plasma cutter and related auxiliary equipment as described above includes suitable housing covers to shield the components for safety reasons and to protect the equipment and its operations from inclement weather and other outside forces and interference. The housing covers have access ports for ease in conducting maintenance and repairs, and are designed to provide for the required air flow. The access ports also include a fuel port for the integrated fuel tank. The structure also includes suitable attachment points and devices for ease of lifting and moving the entire unit structure as needed for cutting work and transport. Operating controls, gauges and instruments are preferably situated on an exterior portion of the structure of the unit. The components are affixed to the structure of the unit, but the plasma cutter is located on a drawer guide that allows it to slide in and out of the structure of the unit for improved access for operation, maintenance and repair purposes. The structure of the unit may also include heavy piping at corners to provide for roll-over protection of the unit.

The compressed air is routed to a plasma cutter by means of suitable hoses. The turbo-charged diesel engine powered electric generator coupled with capacitors supplies the required level of electric power for the proper operation of the plasma cutter. The plasma cutter may be of any of various types known to those skilled in the art, such as plasma cutting systems available from Hypertherm, Inc. The compressed air and electric power from the plasma cutter is directed by suitable hoses and cabling to a torch. In various embodiments, the torch may be mounted to suitable cutting guides, such as a magnetic track for automatically guiding the torch around a pipe to be cut. The cutting guide may also include means for adjusting the location of the nozzle of the torch relative to the portion of the pipe to be cut. For example, the torch may be adjusted relative to the axis of the pipe by various means such as a rack-and-pinion. The torch may also be pivotally adjusted at various angles to the pipe to achieve the precise beveled and other cuts desired. Finally, the position of the nozzle may also be adjusted by a rack-and-pinion along an angle to the surface of the pipe. Such cutting guides are known in the art. Suitable cutting guides include any of various types known to those of skill in the art, including models available from Mathey Dearman, Inc.

These and other features, objects and advantages of the present invention will become better understood from a consideration of the following detailed description of the preferred embodiments and appended claim in conjunction with the drawings as described following.

### BRIEF DESCRIPTION OF THE DRAWINGS

FIG. 1 is a left front perspective view of an embodiment of the system of the present invention.

FIG. 2 is a right rear perspective view of the embodiment of FIG. 1.

FIG. 3 is the view of FIG. 1 with the housing cover removed in order to depict the internal organization of the embodiment with greater clarity.

FIG. 4 is the view of FIG. 2 with the housing cover removed in order to depict the internal organization of the embodiment with greater clarity.

FIG. 5 is a top plan view of the embodiment of FIGS. 1-4.

FIG. 6 is a left front perspective view of an alternative embodiment of the system of the present invention.

FIG. 7 is a right rear perspective view of the embodiment of FIG. 6.

FIG. 8 is the view of FIG. 6 with the housing cover removed in order to depict the internal organization of the embodiment with greater clarity.

FIG. 9 is the view of FIG. 7 with the housing cover removed in order to depict the internal organization of the embodiment with greater clarity.

FIG. 10 is a top plan view of the embodiment of FIGS. 6-9.

### BEST MODE FOR CARRYING OUT THE INVENTION

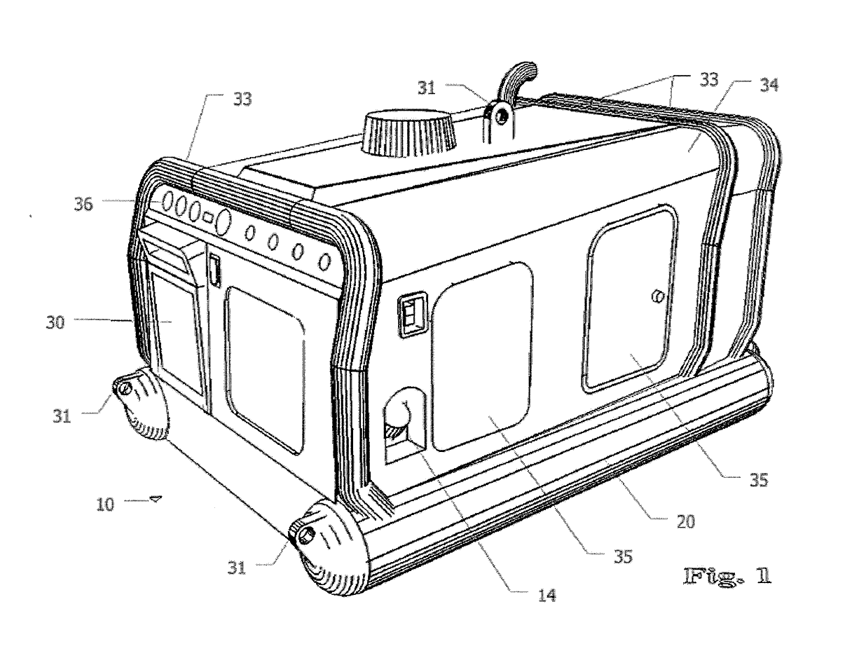

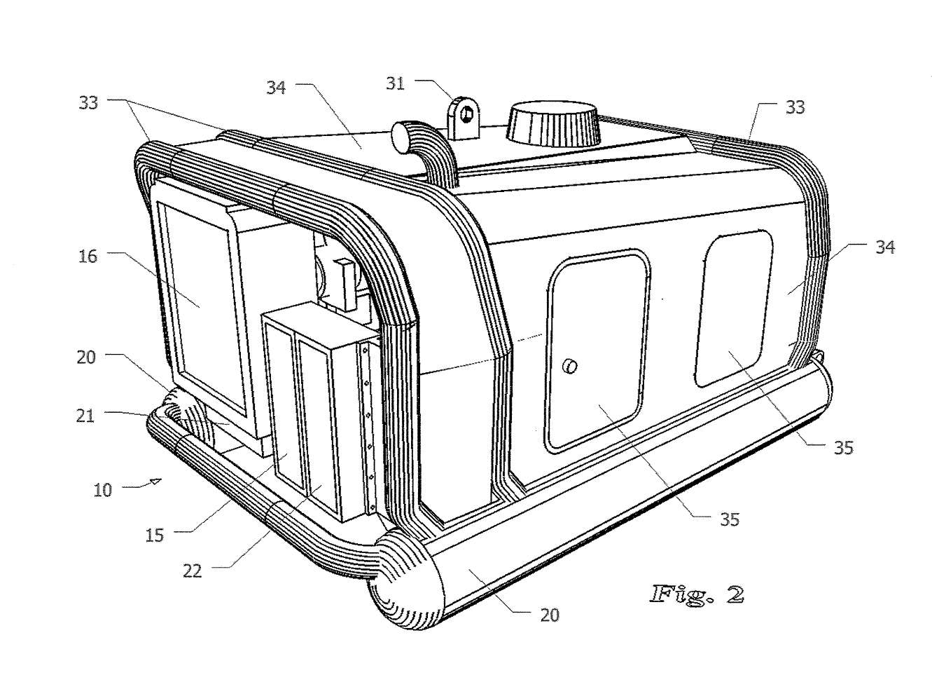

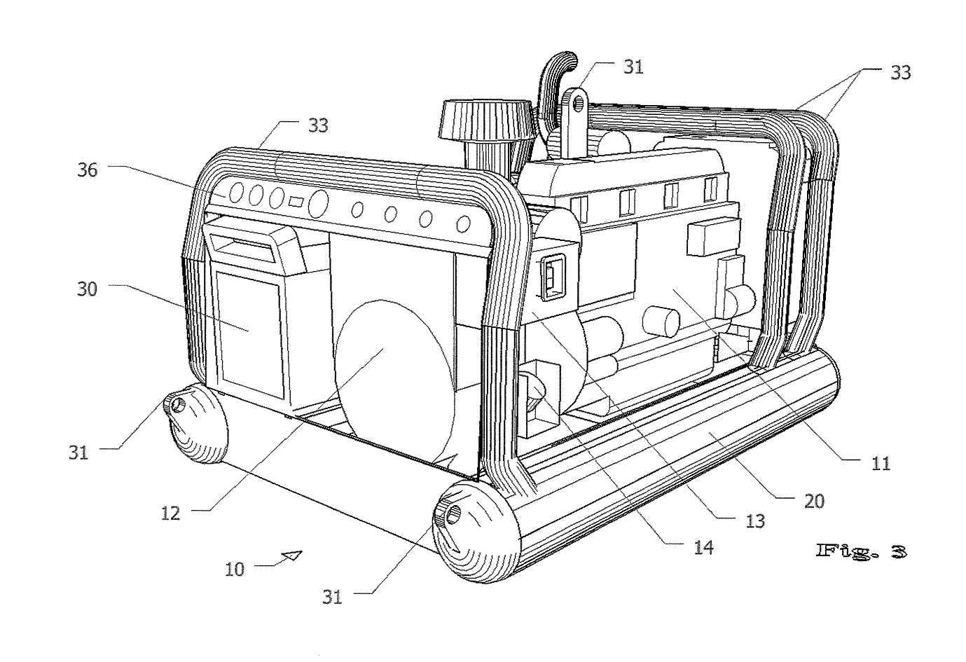

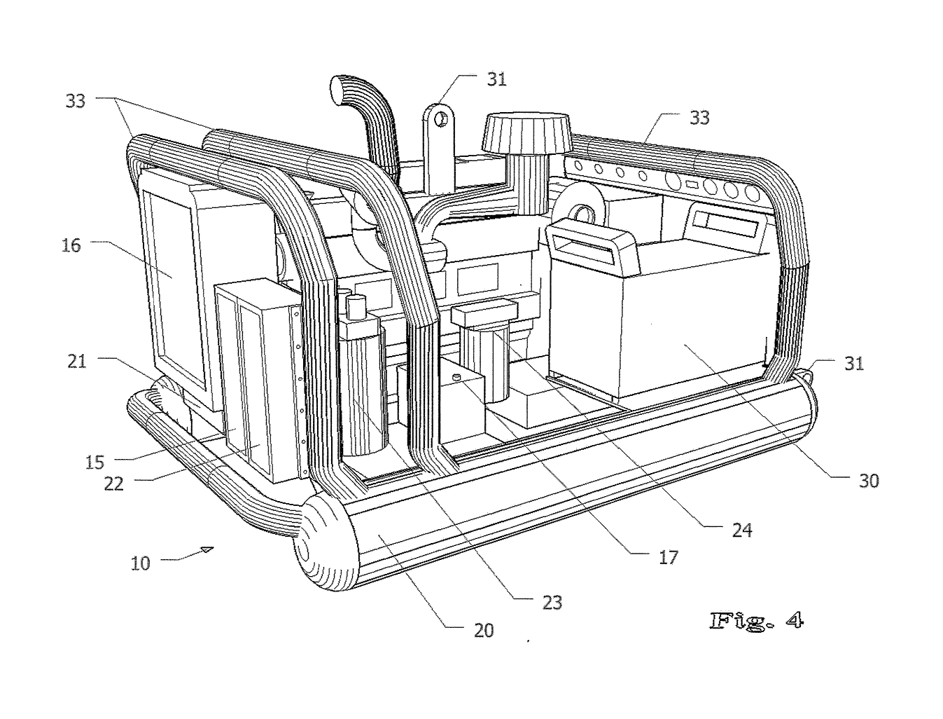

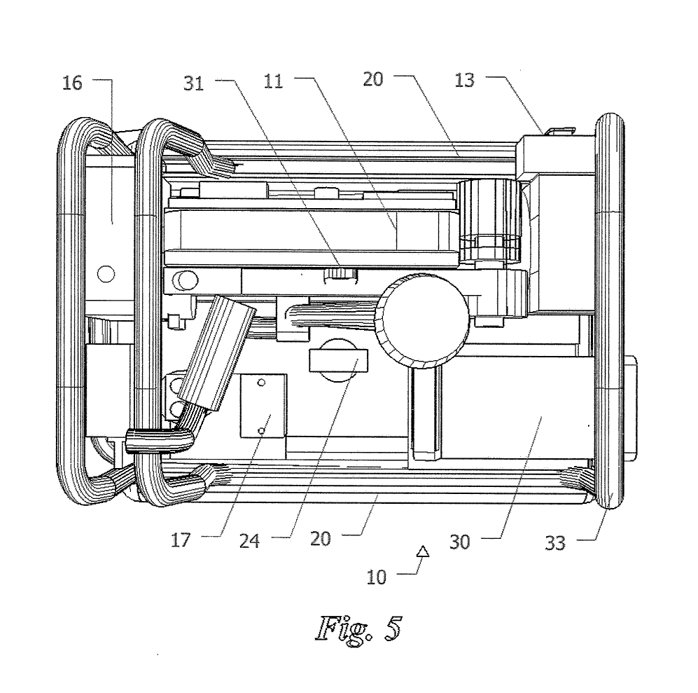

With reference to FIGS. 1-5, an embodiment of the system of the present invention is a self-contained integrated unit 10, including a diesel engine 11 driving an electric generator 12. The electric generator 12 provides electrical power to a plasma cutter 30 as described more fully below. Appropriate electrical circuitry and controls as would be known to those of ordinary skill in the art may be housed in electrical box 13. Appropriate auxiliary equipment for operating the diesel engine and electric generator, including integral fuel tank 14 with cap and fill tube, oil cooler 15, radiator 16, 12 volt battery 17, and electrical circuitry and controls including control panel 36 are provided as well. It is desirable that the entire unit 10 be portable and light enough to ride comfortably in the back of a typical ¾ ton (680 kg) pickup truck or on a small utility trailer. The embodiment of unit 10 also contains a sled feature that permits a worker to simply slide the unit 10 over to the next cutting site. The sled feature includes a pair of air tanks 20 as described more fully below.

The diesel engine 11 also drives a compressor 21, preferably a screw-type compressor, for producing compressed air for the plasma cutter 30 as described below. The compressor 21 is configured with air cooler 22, oil separator 23, water separator 24, and reserve air tanks 20 in order to supply the constant, clean, dry and stable air flow necessary for proper operation of the plasma cutter. Additional auxiliary equipment, such as fans and air filter, known to those of ordinary skill in the art, may be included.

The compressed air is cooled in the water cooler 22, dehumidified in the water separator 24 and cleansed in the air filter (not shown). A pair of compressed air tanks 20 provides for storage of the compressed air. The compressed air tanks 20 are desirably interconnected. The compressed air tanks 20 are situated at bottom opposite sides of the structure that houses the components of the unit 10 so that the tanks 20 also act as skids for ease of movement of the unit 10 to the next cutting site. The walls of the tanks 20 are thicker than would be required for compressed air service alone in order to safely act as skids.

The structure that houses the diesel engine 11 and generator 12, air compressor 21, plasma cutter 30 and related auxiliary equipment as described above includes suitable housing covers 34 to shield the components for safety reasons and to protect the equipment and its operations from inclement weather and other outside forces and interference. The housing covers 34 have access ports 35 for ease in conducting maintenance and repairs, and may also include screened air inlets (not shown) to provide for the required air flow. The access ports also include a fuel port for an integrated fuel tank 14.

The structure also includes suitable attachment points 31 and devices for ease of lifting and/or dragging the entire unit structure as needed for cutting work and transport. Additional attachments as known to those of ordinary skill in the art may also be included with the unit.

Operating controls, gauges and instruments are preferably situated on an instrument panel 36 disposed on an exterior portion of the structure of the unit 10.

The structure of the embodiment of unit 10 also includes heavy piping 33 at corners to provide for roll-over protection of the unit 10.

The compressed air is routed to the plasma cutter 30 by means of suitable hoses as would be known to those of ordinary skill in the art. The plasma cutter 30 may be of any of various types known to those skilled in the art, such as the plasma cutting systems available from Hypertherm, Inc.

The compressed air and electric power from the plasma cutter 30 is directed by suitable hoses and cabling to a torch, which may be any of various types known to those skilled in the art. In various embodiments, the torch may be mounted to suitable cutting guides, such as a magnetic track for automatically guiding the torch around a pipe to be cut. The cutting guide may also include means for adjusting the location of the nozzle of the torch relative to portion of the pipe to be cut. For example, the torch may be adjusted relative to the axis of the pipe by various means such as a rack-and-pinion. The torch may also be pivotally adjusted at various angles to the pipe to achieve precise beveled and other cuts as desired. Finally, the position of the nozzle may also be adjusted by a rack-and-pinion along an angle to the surface of the pipe. Such cutting guides are known in the art. Suitable cutting guides may be of various types known to those skilled in the art, including those models available from Mathey Dearman, Inc.

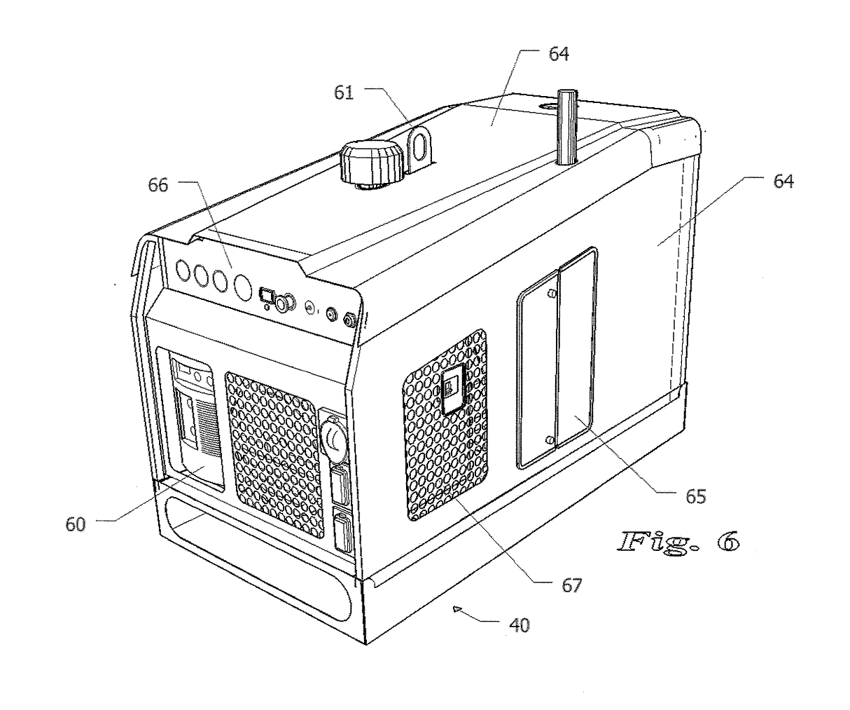

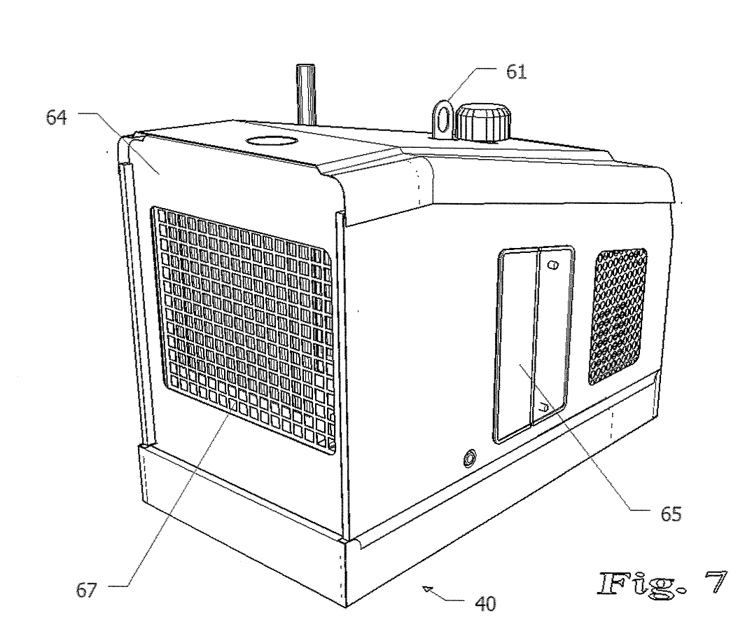

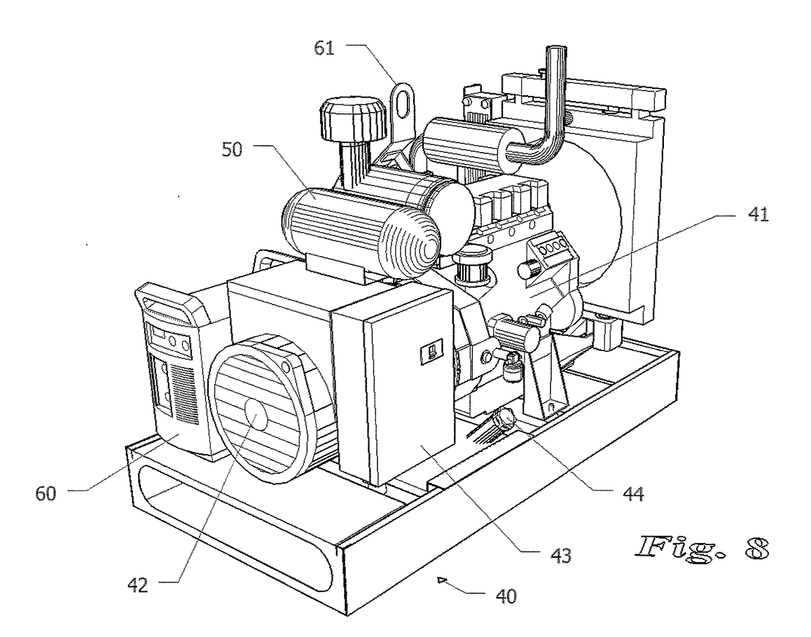

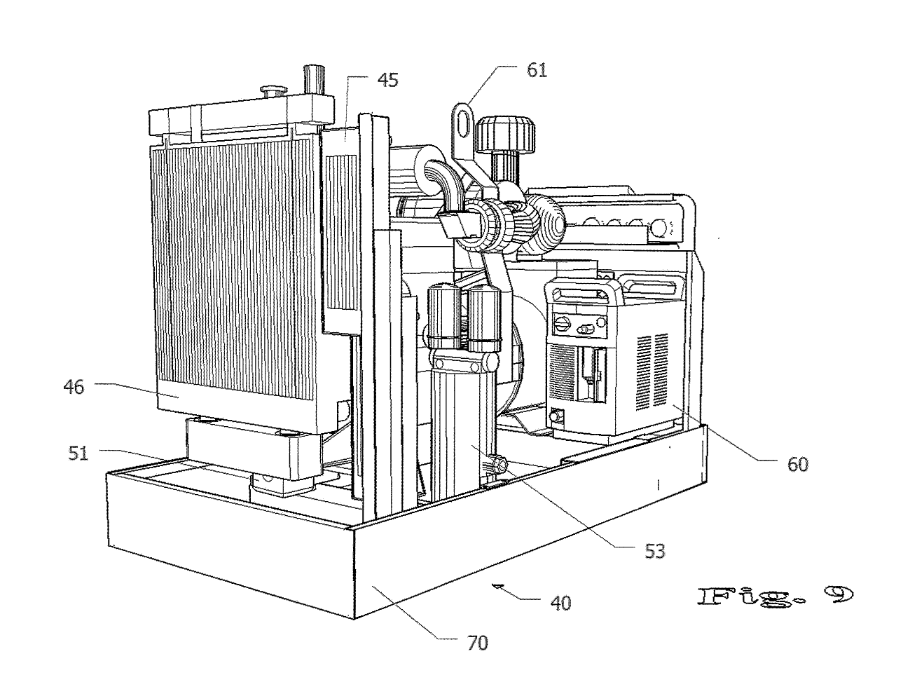

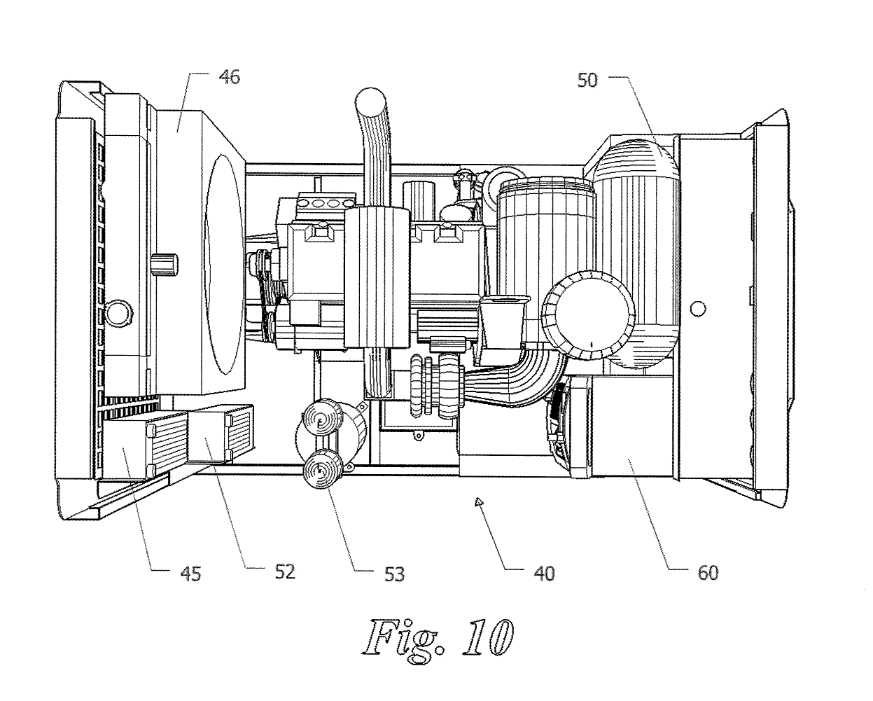

In some applications, it might be desirable to minimize the weight of the self-contained integrated plasma cutting unit. In an alternative embodiment of the unit 40 as shown in FIGS. 6-10, the weight may be minimized by increasing the efficiency of the air compressor 51 so that a smaller air tank 50 has sufficient capacity to serve the plasma cutter 60. Thus the pair of air tanks 20 of the previously-described embodiment of the unit 10 may be eliminated, thereby achieving a unit 40 with a considerable reduction in weight, perhaps as much as ⅓ less than the embodiment of unit 10. With this considerably lighter configuration, the pair of air tanks 20 is not required to act as skids and a lighter frame 70 may be used to support and contain the components. Other components as described above with respect to the embodiment of unit 10 may have analogous components in unit 40, such as diesel engine 41, generator 42, plasma cutter 60, attachment point 61, radiator 46, electrical box 43, fuel tank 44 with fill tube and cap, battery (not shown), instrument panel 66, housing cover 64, access ports 65, air inlets 67, oil cooler 45, air cooler 52, oil separator 53, water separator (not shown), and so forth.

### INDUSTRIAL APPLICABILITY

Although the present invention is described with respect to cutting oil and natural gas pipe, the present invention is not so limited and may be used for the more precise plasma cutting of other metal raw material in the field where electric utility lines are generally unavailable or inaccessible including projects such as bridge construction, industrial maintenance shutdowns, offshore work on ships, barges and oil/gas rigs, and structural steel fabrications in the field. Also the present invention includes auxiliary functions that make use of the capabilities of the individual components allowing simultaneous operation of different but complementary tasks. For example, the unit may be used to power a plasma cutter simultaneously with electric grinders, needle scalers, welding, lighting, and other electrical tools and implements, and as an air compressor to support pneumatic grinders, needle scalers, sandblasters and coating applicators. In some embodiments, the air compressor may be configured to provide compressed air at more than one set of characteristics simultaneously. For example, the air compressor may provide compressed air at a pressure suitable for the plasma cutter while simultaneously delivering air at a different pressure for another purpose such as a pneumatic needle scaler or a jackhammer.

The present invention has been described with reference to certain preferred and alternative embodiments that are intended to be exemplary only and not limiting to the full scope of the present invention.

1. An integrated multi-task metal working system, comprising:
a electrical generator;
an air compressor;
an engine driving said electrical generator and said air compressor; and
a plasma cutter operatively configured to receive electrical power from said electrical generator and compressed air from said air compressor.

2. The system of claim 1, wherein said engine is a diesel engine.

3. The system of claim 1, wherein said diesel engine is turbo-charged.

4. The system of claim 1, wherein said air compressor is a screw-type compressor.

5. The system of claim 1, wherein said system is portable.

6. The system of claim 1, further comprising means for transporting said system by sliding over a ground surface.

7. The system of claim 6, wherein said means for transporting comprises a pair of compressed air tanks operatively connected to said air compressor for storage of compressed air.

8. The system of claim 7, wherein said compressed air tanks are disposed are bottom opposite sides of the system to act as skids.

9. The system of claim 8, wherein said compressed air tanks are interconnected.

10. The system of claim 1, further comprising a structure housing the system.

11. The system of claim 10, further comprising at least one attachment point for lifting and moving the system.

12. The system of claim 10, wherein said structure further comprises a drawer guide and wherein said plasma cutter is mounted onto said drawer guide.

13. The system of claim 10, wherein said structure further comprises roll-over piping.

14. The system of claim 1, further comprising a plasma cutter torch.

15. The system of claim 1, wherein said air compressor is configured to deliver compressed air at a plurality of pressures.
